(19) United States
(12) Patent Application Publication
(10) Pub. No.: US 2008/0022213 A1
(43) Pub. Date: Jan. 24, 2008

(54) Website construction support system, website construction support method and recording medium with website construction support program recorded thereon

(75) Inventor: Masahiko Sugimura, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/790,734

(22) Filed: Apr. 27, 2007

(30) Foreign Application Priority Data
Jul. 18, 2006 (JP) 2006-195840

(51) Int. Cl. G06F 3/00

(52) U.S. Cl. 715/744

(57) ABSTRACT

A website construction support system includes: an input section that enables input of a goal page among webpages; an access log acquisition section that acquires access log information; a calculation section that calculates an access frequency and an arrival frequency based on the access log information; a page judgment section that makes a judgment so that a webpage with the access frequency larger than a boundary condition is a customer-collecting page and a webpage with the arrival frequency larger than a boundary condition is a conversion page; a link decision section that generates, based on the judgment result, notice link including a customer-collecting page as a link source and a conversion page as a link target; and a page generation section that inserts the generated notice link in the customer-collecting page as the link source.

### BACKGROUND OF THE INVENTION

1. Field of the Invention

The present invention relates to a website construction support system, a website construction support method and a recording medium with a website construction support program recorded thereon. More specifically, the present invention relates to a website construction support system, a website construction support method and a recording medium with a website construction support program recorded thereon, by which link information for guiding a user to a goal page is inserted in a webpage.

2. Description of Related Art

Along with the recent development of the Internet-related technology, websites that provide general customers with information about companies and products via the Internet have become widespread (for example, see JP2003-256470A, JP2003-6224A, JP2002-123516A and JP2002-175240A). In particular, increasing number of websites are used for business recently. As one example of making use of a website for business, a website W as shown in FIG. 17 can be considered, which is constructed so as to guide a user who accesses the website W to a page P_{g} (goal page) contributing to business (i.e., contributing to a profit of the company). In this specification, the goal page P_{g} means, for example, a page that “introduces a product”, a page from which “catalogues and information can be downloaded”, a page from which “an evaluation copy can be downloaded”, a page on which “a purchase procedure is completed”, a page for “inquiries to a sales representative” or the like.

Meanwhile, such a website W should be constructed based on a persistent concept in terms of clarity, consistency, ease of management and the like. In the above-stated example of FIG. 17, for example, the page PS about “introductory seminar on the SOX Act compliance” should be constructed at a layer below “web-seminars for business managers” (at the first lower layer). The page P_{d} about “advantages of introducing the SOX Act compliance solution” should be constructed at a layer below “introduction of our solutions” (at the second lower layer). Furthermore, the page P_{g} from which “a catalogue of the SOX Act compliance solution can be downloaded” should be constructed at a layer below the page P_{d} about “advantages of introducing the SOX Act compliance solution”.

For these reasons, in order for a user to move from the page Pₛ about “introductory seminar on the SOX Act compliance” to the page P_{g} contributing to business, from which “a catalogue of the SOX Act compliance solution can be downloaded”, the user has to return to a top page Pt of the website W. Therefore, even when a user who has read the page Pₛ about “introductory seminar on the SOX Act compliance” tries to get a catalogue of the SOX Act compliance solution, it is difficult for the user to reach the page P_{g} from which “a catalogue of the SOX Act compliance solution can be downloaded”. Such a difficulty might lead to a loss of a business opportunity.

In order to avoid such a situation, a site administrator of the website W generates link information based on his/her own empirical rule, including the page Pₛ about “introductory seminar on the SOX Act compliance” as a link source and the page P_{g} from which “a catalogue of the SOX Act compliance solution can be downloaded” as a link target, and inserts this link information in the page Pₛ about “introductory seminar on the SOX Act compliance” as the link source. Thereby, a user who accesses the page Pₛ about “introductory seminar on the SOX Act compliance” can be guided to the page P_{g} from which “a catalogue of the SOX Act compliance solution can be downloaded”.

### SUMMARY OF THE INVENTION

According to the conventional technology, however, the following problems arise because when generating the above-stated link information, the site administrator selects the page as a link source and the page as a link target from a plurality of webpages constituting the website.

As a first problem, when generating the link information, the site administrator tends to generate the link information based on his/her own empirical rule or through intuition without measuring the customer-collecting ability and the conversion ability of the plurality of webpages. Moreover, after inserting the link information, the site administrator often does not evaluate the effectiveness of the inserted link information. Therefore, when a plurality of administrators manage the website, it is difficult to generate effective link information unless the plurality of administrators share the information well.

As a second problem, the conventional technology requires considerable labor costs for the site administrator. For example, a company website is composed of enormous webpages. Therefore, the site administrator has to examine the relationship among the enormous webpages and insert link information therein. Furthermore, it is not practical for the site administrator to analyze enormous amounts of access log information of the website and generate effective link information.

Therefore, with the foregoing in mind, it is an object of the present invention to provide a website construction support system, a website construction support method and a recording medium with a website construction support program recorded thereon, by which link information for guiding a user to a goal page is effectively inserted in a webpage without the necessity of labor costs.

In order to attain the above-mentioned object, a website construction support system of the present invention includes: an input section that enables input of a goal page among a plurality of webpages constituting a website; an access log acquisition section that acquires access log information representing history of accesses to the webpages; an access frequency calculation section that calculates an access frequency to the webpages based on the access log information acquired by the access log acquisition section; an arrival frequency calculation section that calculates an arrival frequency at the goal page based on the access log information acquired by the access log acquisition section; a page judgment section that makes a judgment so that a webpage with the access frequency larger than a boundary condition is a customer-collecting page and a webpage with the arrival frequency larger than a boundary condition is a conversion page; a page judgment result storage section that stores a result of the judgment by the page judgment section; a link decision section that generates, based on the judgment result stored in the page judgment result storage section, link information including a customer-collecting page as a link source and a conversion page as a link target; and a page generation section that inserts the link information generated by the link decision section in the customer-collecting page as the link source.

In the website construction support system of the present invention, the page judgment section makes a judgment so that a webpage with the access frequency larger than a boundary condition is a customer-collecting page and a webpage with the arrival frequency larger than a boundary condition is a conversion page. Herein, the page judgment result storage section stores a result of the judgment by the page judgment section. The link decision section generates, based on the judgment result, link information including a customer-collecting page as a link source and a conversion page as a link target. The page generation section inserts the link information in the customer-collecting page as the link source.

According to the website construction support system of the present invention, the link information including a customer-collecting page as a link source and a conversion page as a link target is inserted in the customer-collecting page as the link source. This allows a large number of users who access the customer-collecting page to be guided to the conversion page, thus increasing the number of users who arrive at the goal page. Moreover, since there is no need for a site administrator to generate link information as in the conventional configuration, labor costs for the site administrator can be reduced.

Preferably, the website construction support system of the present invention further includes a link evaluation section that judges, as ineffective link information, link information including a customer-collecting page as a link source with an arrival frequency smaller than a threshold or link information including a conversion page as a link target with an access frequency smaller than a threshold. Preferably, the link decision section decides, from webpages judged as conversion pages by the page judgment section, a conversion page that replaces a conversion page as a link target in ineffective link information, and newly generates link information including the decided conversion page as a link target, and the page generation section inserts the link information newly generated by the link decision section in the customer-collecting page as the link source, instead of the ineffective link information.

According to the above configuration, the link evaluation section judges link information including a customer-collecting page as a link source with an arrival frequency smaller than a threshold to be ineffective link information. Further, the link evaluation section judges link information including a conversion page as a link target with an access frequency smaller than a threshold to be ineffective link information. Thereby, link information incapable of making a user arrive at a goal page can be judged as ineffective link information. Further, the link decision section decides, from webpages judged as conversion pages by the page judgment section, a conversion page that replaces a conversion page as a link target in ineffective link information, and newly generates link information including the decided conversion page as a link target. The page generation section inserts the newly generated link information in the customer-collecting page as the link source, instead of the ineffective link information. Thereby, new link information can be inserted in the customer-collecting page as the link source instead of the ineffective link information incapable of making a user arrive at a goal page.

In the website construction support system of the present invention, preferably, the link evaluation section judges, as effective link information, link information including a customer-collecting page as a link source with an arrival frequency larger than a threshold and a conversion page as a link target with an access frequency larger than a threshold.

According to the above configuration, the link evaluation section judges, as effective link information, link information including a customer-collecting page as a link source with an arrival frequency larger than a threshold and a conversion page as a link target with an access frequency larger than a threshold. Thereby, link information capable of making a user arrive at a goal page can be judged as effective link information.

In the website construction support system of the present invention, preferably, the link evaluation section uses the boundary conditions for the judgment by the page judgment section of customer-collecting pages and conversion pages as the thresholds.

According to the above configuration, the page judgment by the page judgment section and the evaluation of link information by the link evaluation section can be made based on the same criteria, and therefore the configuration of the website construction support system can be simplified.

In the website construction support system of the present invention, preferably, the link decision section decides, from webpages judged as conversion pages by the page judgment section, a conversion page as a link target at random, and generates link information including the decided conversion page as a link target.

According to the above configuration, the link decision section decides, from webpages judged as conversion pages by the page judgment section, a conversion page as a link target at random, and generates link information including the decided conversion page as a link target. Therefore, effective link information that a site manager would not come up with may be generated.

In the website construction support system of the present invention, preferably, the link decision section calculates a similarity between the customer-collecting page as the link source and webpages judged as conversion pages by the page judgment section and generates link information including a webpage having the highest similarity as a link target.

According to the above configuration, link information can be generated between webpages having a closer relationship.

In the website construction support system of the present invention, preferably, the arrival frequency calculation section calculates the arrival frequency based on a ratio between the access frequency to the webpages and the number of arrivals to the goal page after accessing the webpages.

A website construction support method according to the present invention includes the steps of: an input step of enabling input of a goal page among a plurality of webpages constituting a website; an access log acquisition step of acquiring access log information representing history of accesses to the webpages; an access frequency calculation step of calculating an access frequency to the webpages based on the access log information acquired at the access log acquisition step; an arrival frequency calculation step of calculating an arrival frequency at the goal page based on the access log information acquired at the access log acquisition step; a page judgment step of making a judgment so that a webpage with the access frequency larger than a boundary condition is a customer-collecting page and a webpage with the arrival frequency larger than a boundary condition is a conversion page; a page judgment result storage step of storing a result of the judgment at the page judgment step in a page judgment result storage section; a link decision step of generating, based on the judgment result stored in the page judgment result storage section, link information including a customer-collecting page as a link source and a conversion page as a link target; and a page generation step of inserting the link information generated at the link decision step in the customer-collecting page as the link source.

According to the website construction support method of the present invention as well, the link information including a customer-collecting page as a link source and a conversion page as a link target is inserted in the customer-collecting page as the link source. This allows a large number of users who access the customer-collecting page to be guided to the conversion page, thus increasing the number of users who arrive at the goal page. Moreover, since there is no need for a site administrator to generate link information as in the conventional configuration, labor costs for the site administrator can be reduced.

Note here that the order of the above-stated steps is not limited especially, and the access frequency calculation step may follow the arrival frequency calculation step for example, or they may be performed in the reversed order.

According to a recording medium of the present invention with a website construction support program recorded thereon, the website construction support program makes a computer execute the processes of: an input process of enabling input of a goal page among a plurality of webpages constituting a website; an access log acquisition process of acquiring access log information representing history of accesses to the webpages; an access frequency calculation process of calculating an access frequency to the webpages based on the access log information acquired at the access log acquisition process; an arrival frequency calculation process of calculating an arrival frequency at the goal page based on the access log information acquired at the access log acquisition process; a page judgment process of making a judgment so that a webpage with the access frequency larger than a boundary condition is a customer-collecting page and a webpage with the arrival frequency larger than a boundary condition is a conversion page; a page judgment result storage process of storing a result of the judgment at the page judgment process in a page judgment result storage section; a link decision process of generating, based on the judgment result stored in the page judgment result storage section, link information including a customer-collecting page as a link source and a conversion page as a link target; and a page generation process of inserting the link information generated at the link decision process in the customer-collecting page as the link source.

The recording medium of the present invention with a website construction support program recorded thereon has the effects similar to those from the above-stated website construction support system and the website construction support method.

These and other advantages of the present invention will become apparent to those skilled in the art upon reading and understanding the following detailed description with reference to the accompanying figures.

### BRIEF DESCRIPTION OF THE DRAWINGS

FIG. 1 schematically shows a website made up of a plurality of webpages.

FIG. 2 shows one exemplary website made up of a plurality of webpages in a tree configuration.

FIG. 3 is a block diagram schematically showing the configuration of a website construction support system according to Embodiment 1 of the present invention.

FIG. 4 shows one exemplary access log information stored in an access log information storage section of a web server of Embodiment 1 of the present invention.

FIG. 5 schematically shows one exemplary page judgment process by a page judgment section in the above-stated website construction support system.

FIG. 6 shows one exemplary data configuration of a page judgment result storage section in the above-stated website construction support system.

FIG. 7 schematically shows one exemplary link decision process by a link decision section in the above-stated website construction support system.

FIG. 8 schematically shows one exemplary data configuration of a link storage section in the above-stated website construction support system.

FIG. 9 shows one exemplary webpage generated by a page generation section in the above-stated website construction support system.

FIG. 10 schematically shows one exemplary page judgment process by a page judgment section in the above-stated website construction support system.

FIG. 11 is a flowchart briefly showing an operation of the above-stated website construction support system.

FIG. 12 is a flowchart showing an exemplary process for calculating an arrival frequency by a calculation section (an arrival frequency calculation section) in the above-stated website construction support system.

FIG. 13 is a flowchart showing one exemplary process for evaluating a notice link in the above-stated website construction support system.

FIG. 14 is a flowchart showing another exemplary process for calculating an arrival frequency by a calculation section (an arrival frequency calculation section) in the above-stated website construction support system.

FIG. 15 is a block diagram schematically showing the configuration of a website construction support system according to Embodiment 2 of the present invention.

FIG. 16 is a block diagram schematically showing the configuration of a website construction support system according to Embodiment 3 of the present invention.

FIG. 17 shows a website made up of a plurality of webpages in a tree configuration as a conventional example.

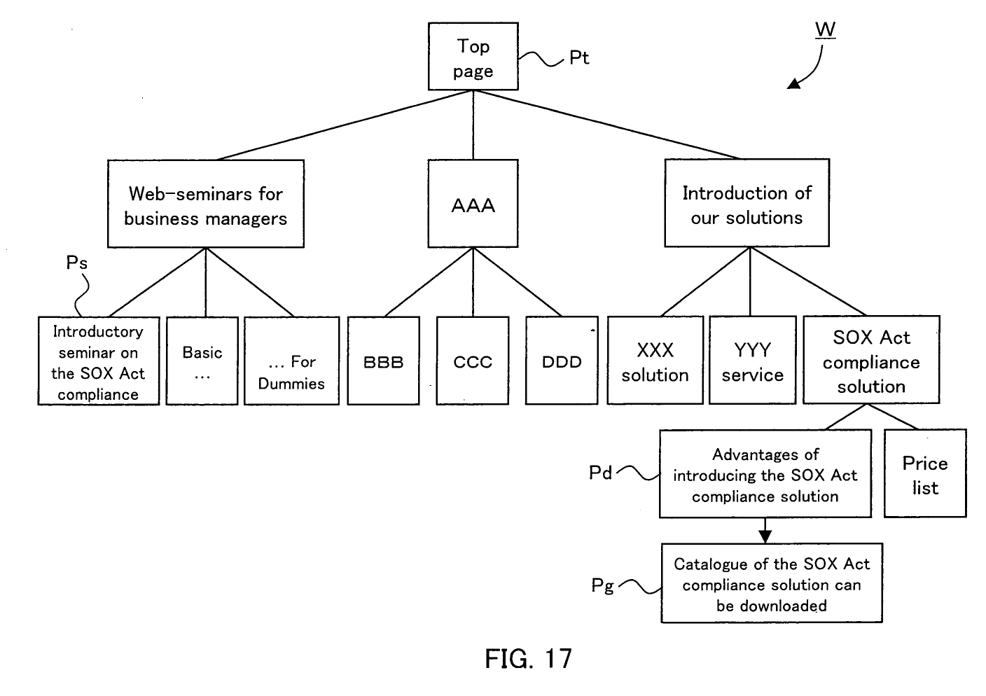

### DETAILED DESCRIPTION OF THE INVENTION

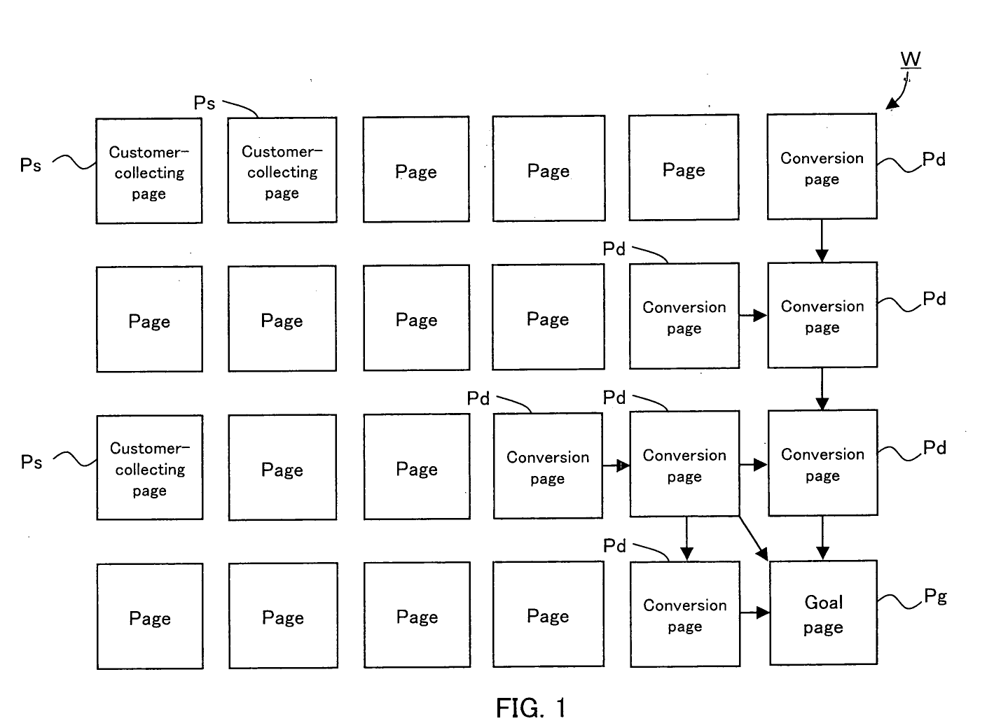

As shown in FIG. 1, among a plurality of webpages constituting the website W, there are pages (customer-collecting pages) Pₛ having the excellent ability to collect many users (customer-collecting ability). The customer-collecting pages PS refer to, for example, a page that “provides knowledge and entertainment demanded by users” and a page that is “hit at a higher-rank by a search engine”. Meanwhile, there are pages P_{d} (conversion pages) having the excellent ability to guide users to a goal page (conversion ability). The conversion pages P_{d} refer to, for example, a page that “provides clear explanations about advantages of products and services” and a page that “suggests product application scenes”.

Note here that if a user who accesses a customer-collecting page Pₛ can be guided to a conversion page P_{d}, then the behavior of the user to arrive at the goal page P_{g} from the conversion page P_{d} can be expected. That is, the number of users who access the goal page P_{g} can be increased, and therefore the improvement of the business effectiveness of the website W can be expected.

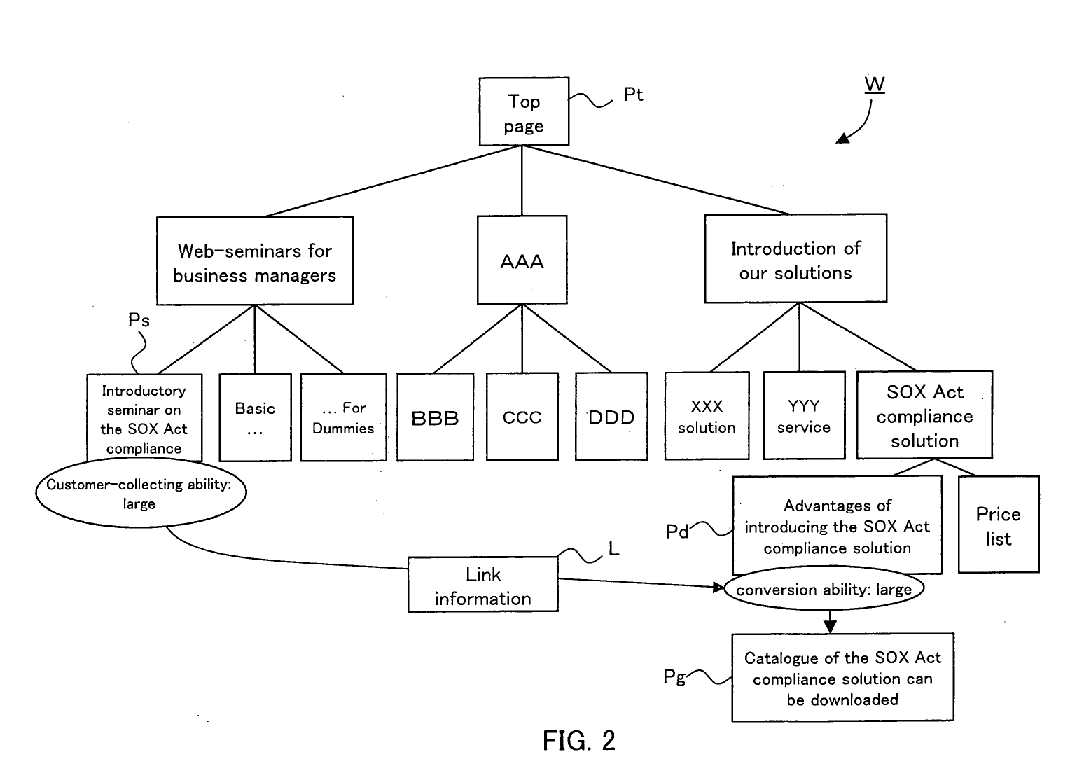

For example, it is assumed as shown in FIG. 2 that the website W is constructed to include a plurality of webpages in a tree configuration. In this example, the page about “introductory seminar on the SOX Act compliance” corresponds to the customer-collecting page Pₛ, the page about “advantages of introducing the SOX Act compliance solution” corresponds to the conversion page P_{d}, and the page from which “a catalogue of the SOX Act compliance solution can be downloaded” corresponds to the goal page P_{g}. Herein, if a user can be successfully guided from the customer-collecting page Pₛ about “introductory seminar on the SOX Act compliance” to the conversion page P_{d} about “advantages of introducing the SOX Act compliance solution”, the number of users who arrive at the goal page P_{g} for “downloading a catalogue of the SOX Act compliance solution” after the conversion page P_{d} about “advantages of introducing the SOX Act compliance solution” can be increased. In other words, if a user can be successfully guided to the goal page P_{g} from which “a catalogue of the SOX Act compliance solution can be downloaded”, the improvement of the business effectiveness such as an increase in the number of the downloaded catalogues and the development to business talks will be expected.

Thus, the inventor of the present invention has found the followings: that is, a plurality of webpages of the website W are analyzed as to whether they are customer-collecting pages or conversion pages, and link information L is generated so as to include the customer-collecting page Pₛ about “introductory seminar on the SOX Act compliance” as a link source and the conversion page P_{d} about “advantages of introducing the SOX Act compliance solution” as a link target. Then, this link information L is inserted in the page about “introductory seminar on the SOX Act compliance” as the link source, whereby a user can be effectively and easily guided from the customer-collecting page Pₛ about “introductory seminar on the SOX Act compliance” to the conversion page P_{d} about “advantages of introducing the SOX Act compliance solution”.

The following describes more specific embodiments of the present invention in detail, with reference to the drawings.

### Embodiment 1

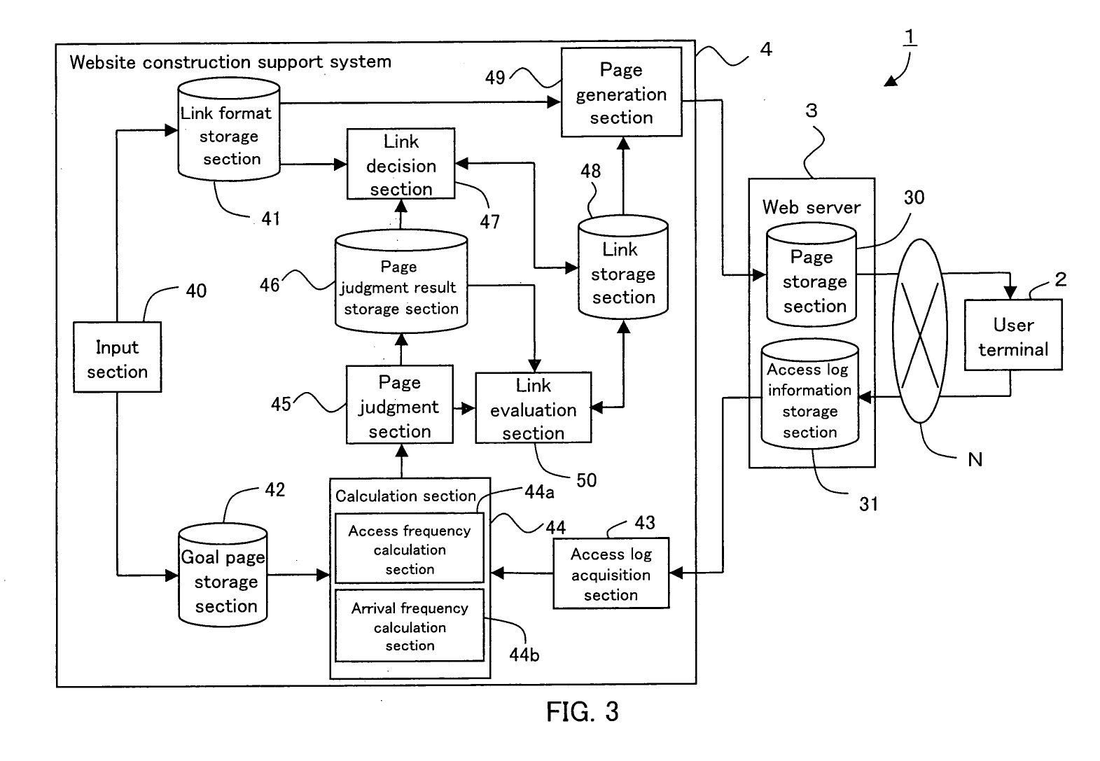

FIG. 3 is a block diagram schematically showing the configuration of a network system 1 according to the present embodiment. That is, the network system 1 of the present embodiment includes a user terminal 2, a web server 3 and a website construction support system 4. The user terminal 2 and the web server 3 are connected via the Internet N. The website construction support system 4 and the web server 3 are connected via an Ethernet®. Herein, the user terminal 2 is a terminal capable of displaying (browsing) webpages written in Hyper Text Markup Language (HTML). The web server 3 stores webpages and sends a webpage in response to a request from a browsing means such as a browser. The website construction support system 4 is a system that generates link information (hereinafter called “notice link”) that is for guiding a user to a goal page and inserts the notice link in a webpage. Although FIG. 3 illustrates only one user terminal 2, web server 3 and website construction support system 4 for simplifying the explanation, the number of the user terminals 2, the web servers 3 and the website construction support systems 4 constituting the network system 1 are not limited. Furthermore, a Domain Name System (DNS) server, a Dynamic Host Configuration Protocol (DHCP) server and the like may be present on the network system 1.

Prior to the explanation about the detailed configuration of the website construction support system 4, the following briefly describes the overall configuration of the network system 1.

The user terminal 2 is mainly composed of a personal computer, and is provided with a browser as a browsing means. When a user activates the browser, the user terminal 2 sends a Hyper Text Transfer Protocol (HTTP) request to the web server 3. When accepting the HTTP request from the user terminal 2, the web server 3 returns HTML of a webpage as a HTTP response to the user terminal 2 in accordance with the HTTP request. The user terminal 2 displays the received webpage.

The web server 3 is provided with a page storage section 30 and an access log information storage section 31.

The page storage section 30 stores HTML of webpages. This HTML is composed of text, images, sounds, moving images, hyperlink to other HTML, layout information and the like. The page storage section 30 further stores a plurality of webpages as a webpage group. This webpage group forms a website.

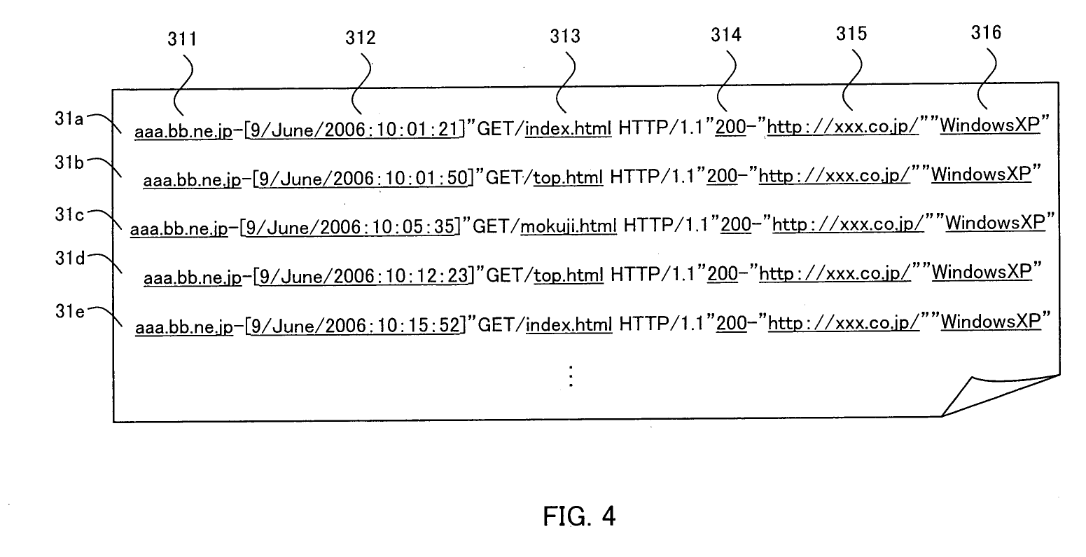

The access log information storage section 31 stores access log information that shows access history of the user terminal 2 to a webpage. The access log information storage section 31 is formed as a part of the region of a hard disk, for example. That is, when a user accesses a webpage provided by the web server 3 through the browser of the user terminal 2, the browser sends a HTTP request to the web server 3. The web server 3 generates one log data based on this HTTP request. Therefore, the access log information is formed as the aggregation of a plurality of log data 31a, 31b, 31c . . . as shown in FIG. 4. The access log information further contains a client name 311 of the user terminal 2 that has made access, the access date and time 312, a requested file name 313, a HTTP condition code 314, a referrer 315 that shows a Uniform Resource Locator (URL) that the user terminal 2 has accessed immediately before, user environment data 316 that shows the environment of the user terminal 2 and the like. FIG. 4 shows an exemplary access log information complying with Apache that is currently widespread as a web server software. However, the mode of the access log information is not limited to the specific example of FIG. 4. The contents of data included in the access log information and the format of the access log information may be any one depending on the type of the web server software constituting the web server 3 and the setting of the operational parameters of this software.

The website construction support system 4 includes an input section 40, a link format storage section 41, a goal page storage section 42, an access log acquisition section 43, a calculation section 44, a page judgment section 45, a page judgment result storage section 46, a link decision section 47, a link storage section 48, a page generation section 49 and a link evaluation section 50.

The input section 40 allows a site administrator to specify one webpage among a plurality of webpages constituting the website using URL, and allows the site administrator to input the number of notice links to be inserted in this webpage and their insertion positions that are data of coordinates of the notice links. The input section 40 further allows the site administrator to input URL of a goal page to which a user should be guided finally from the plurality of webpages constituting the website. Herein, the input section 40 enables the site administrator to input URLs of a plurality of goal pages instead of one goal page. The input section 40 may be composed of any input device such as a keyboard, a mouse, a ten-key, a tablet, a touch panel or a voice recognition unit.

The link format storage section 41 stores the number of notice links to be inserted in a webpage and their inserted positions that are data of coordinates of the notice links, which are associated with each of the plurality of webpages.

The goal page storage section 42 stores the URL of the goal page input through the input section 40. When a plurality of goal pages are input through the input section 40, the goal page storage section 42 stores URLs of the plurality of goal pages. Herein the goal page refers to, for example, a page contributing to business (i.e., contributing to a profit of the company) and includes a page that “introduces a product”, a page from which “catalogues and information can be downloaded”, a page from which “an evaluation copy can be downloaded”, a page on which “a purchase procedure is completed”, a page for “inquiries to a sales representative” or the like.

The access log acquisition section 43 acquires the access log information stored in the access log information storage section 31 of the web server 3. The access log acquisition section 43 outputs the acquired access log information to the calculation section 44 described later. The access log information stored in the access log information storage section 31 may be acquired online via an Ethernet® or offline via a recording medium such as DVD, MO, CD, flexible disk or magnetic tape. When the access log information is acquired online, the access log information may be transferred one by one from the web server 3 or a predetermined period of or a predetermined amount of access log information may be collectively transferred from the web server 3. The access log acquisition section 43 may store the acquired access log information on a storage unit such as a hard disk.

Based on the access log information acquired by the access log acquisition section 43, the calculation section 44 calculates an access frequency and an arrival frequency of the webpages. For this purpose, the calculation section 44 includes an access frequency calculation section 44a and an arrival frequency calculation section 44b.

The access frequency calculation section 44a calculates an access frequency to a webpage. The access frequency calculation section 44a calculates the access frequency based on page views, for example. More specifically, every time a HTTP request is transmitted from the browser of the user terminal 2 to the web server 3, one access (one page view) is counted.

In addition to the above-stated page views, another method for calculating the access frequency is based on the session number. More specifically, in one website, a series of HTTP requests from the browser of the user terminal 2 to the web server 3 without predetermined time period (typically 30 to 40 min.) or longer of intervals is counted as one access (one session). According to the calculation based on the session number, an access frequency that reflects the access condition of users more accurately can be obtained than the calculation based on page views.

In addition to the above-stated page views and session number, still another method for calculating the access frequency is based on the unique user number. More specifically, no matter how many times a HTTP request is sent from the browser of the user terminal 2 to the web server 3 during a predetermined time period, it is counted as one access (one unique user). Incidentally, whether or not to be a unique user may be determined using a client name (IP address) of the user terminal 2, cookie information and the like.

The arrival frequency calculation section 44b calculates an arrival frequency at the goal page. In the case where URLs of a plurality of goal pages are stored in the goal page storage section 42, the arrival frequency calculation section 44b calculates an arrival frequency for each of the goal pages. Herein, the arrival frequency calculation section 44b calculates the arrival frequency based on the session number, for example. More specifically, the arrival frequency calculation section 44b calculates the arrival frequency based on the ratio between the access frequency to the webpage calculated based on the session number and the arrival number to the goal page following the access to the webpage. Alternatively, the arrival frequency calculation section 44b may calculate the arrival frequency using a correlation coefficient, a Temporal Difference (TD) learning or the like.

The page judgment section 45 compares the access frequency to the webpage calculated by the access frequency calculation section 44a with a boundary condition and judges a webpage having a larger access frequency than the boundary condition as a “customer-collecting page”. The page judgment section 45 also compares the arrival frequency of the webpage calculated by the arrival frequency calculation section 44b with a boundary condition, and judges a webpage having a larger arrival frequency than the boundary condition as a “conversion page”. In other words, a “customer-collecting” page is a page having an excellent ability to collect more customers (customer-collecting ability), whereas a “conversion page” is a page having an excellent ability of guiding a user to a goal page (conversion ability).

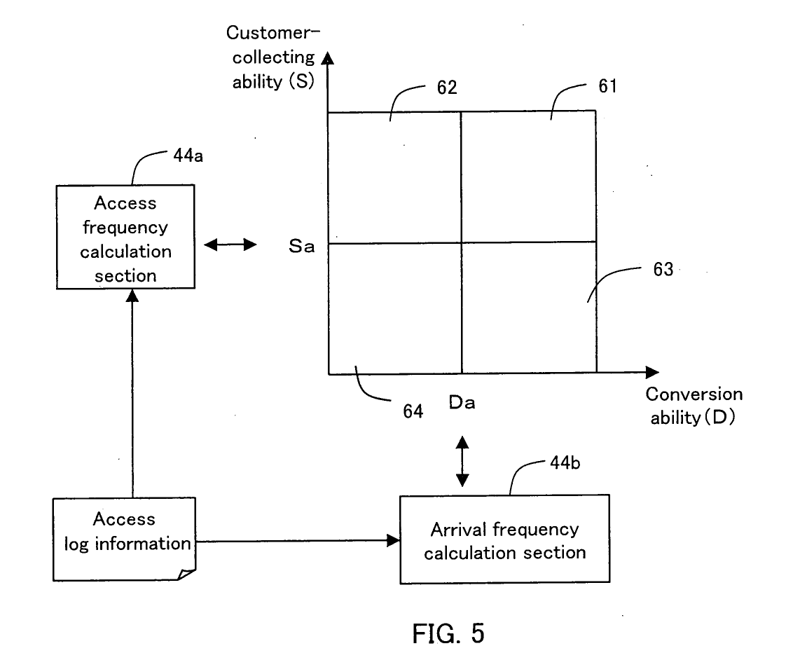

For example, the page judgment section 45, as shown in FIG. 5, divides a two-dimensional space represented by the customer-collecting ability S as the access frequency and the conversion ability D as the arrival frequency into four regions 61 to 64 using the boundary condition (Sa) for the access frequency and the boundary condition (Da) for the arrival frequency, and finds which region a webpage belongs to among the four regions 61 to 64. Herein, a webpage belonging to the region 61 with S≧Sa and D≧Da is called a “customer-collecting conversion page”. A webpage belonging to the region 62 with S≧Sa and D<Da is called a “customer-collecting page”. A webpage belonging to the region 63 with S<Sa and D≧Da is called a “conversion page”. A webpage belonging to the region 64 with S<Sa and D<Da is called an “unknown quantity page”. Incidentally, the boundary condition (Sa) for the access frequency and the boundary condition (Da) for the arrival frequency may be predetermined values or a site administrator may input the boundary conditions (Sa, Da) through the input section 40 and may change the boundary conditions (Sa, Da) dynamically.

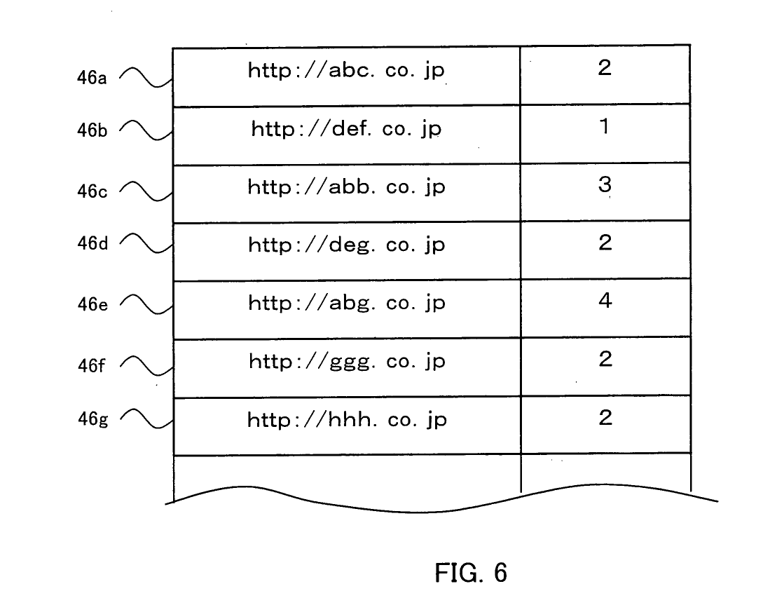

The page judgment result storage section 46 stores judgment results by the page judgment section 45. That is, the page judgment result storage section 46 stores a judgment result about which type of pages including “customer-collecting conversion page”, “customer-collecting page”, “conversion page” and “unknown quantity page” the webpage belongs to. For this purpose, as shown in FIG. 6 for example, the page judgment result storage section 46 stores a plurality of records 46a, 46b, 46c . . . each represented with URL of a webpage and a judgment result of the webpage. Herein, it is assumed that a webpage with a judgment result of “138 is a customer-collecting conversion page”. Similarly, a webpage with a judgment result of “238 is a “customer-collecting page”, a webpage with a judgment result of “338 is a “conversion page” and a webpage with a judgment result of “438 is a “unknown quantity page”.

The link decision section 47 generates a notice link based on the judgment results stored in the page judgment result storage section 46 so that a “customer-collecting page” is a link source and a “conversion page” is a link target. More specifically, the link decision section 47 reads out the number of notice links stored in the link format storage section 41 and decides “conversion pages” as link targets corresponding to the read out number among the “conversion pages” judged by the page judgment section 45 at random based on random numbers, for example. Since the link decision section 47 decides the “conversion pages” as link targets at random, an effective notice link that a site manager would not come up with may be generated. Alternatively, the link decision section 47 may decide a “customer-collecting conversion page” as a link source or as a link target.

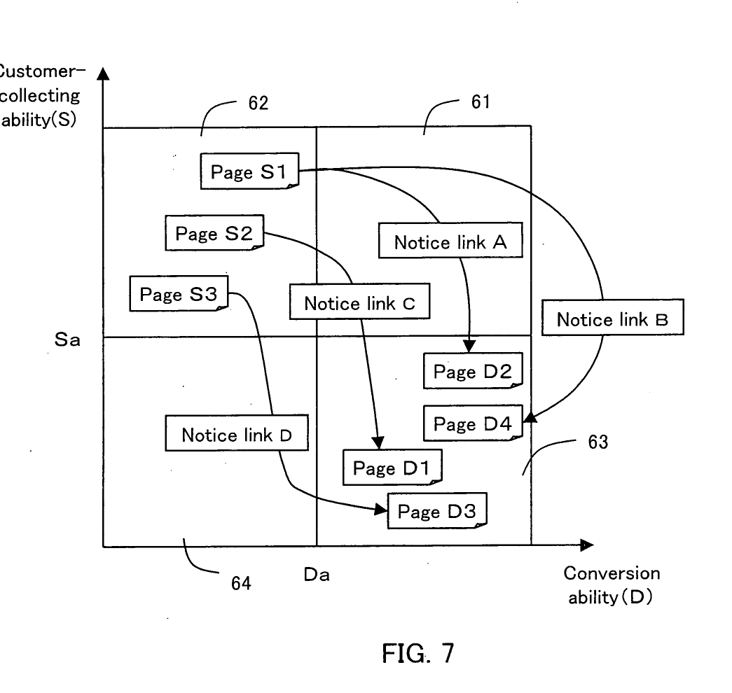

As one example, as shown in FIG. 7, it is assumed that the judgment by the page judgment section 45 results in that pages Si to S3 are “customer-collecting pages” and pages D1 to D4 are “conversion pages”. That is to say, the page judgment result storage section 46 stores the judgment result “238 for pages Si to S3 representing a “customer-collecting page” and “338 for pages D1 to D4 representing a “conversion page”. Furthermore, it is assumed that the link format storage section 41 stores “2” as the number of notice links in page S1, “138 as the number of notice links in page S2 and “138 as the number of notice links in page S3.

Herein, based on the number of notice links “238 to be inserted in the page S1 as a link source, the link decision section 47 decides two pages at random from the webpages judged as “conversion pages” by the page judgment section 45. For instance, the link decision section 47 decides page D2 and page D4 as the “conversion pages” as link targets. The link decision section 47 generates a notice link A including page S1 as a link source and page D2 as a link target, and a notice link B including page S1 as a link source and page D4 as a link target. The link decision section 47 further generates a notice link C including page S2 as a link source and page D1 as a link target, and a notice link D including page S3 as a link source and page D3 as a link target. Herein, the link decision section 47 writes information about the generated notice links in the link storage section 48 described later.

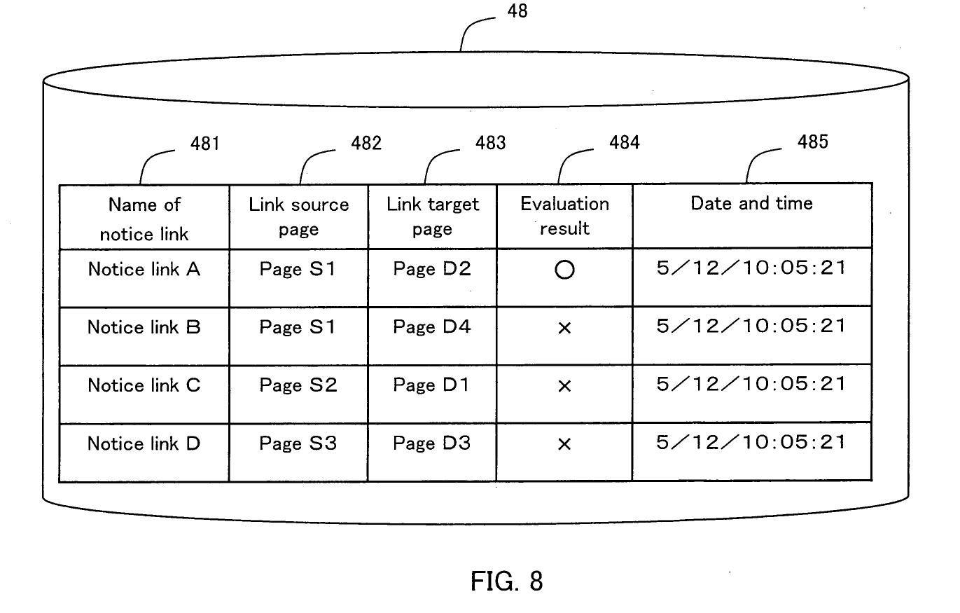

The link storage section 48 stores the information about notice links generated by the link decision section 47. For example, as shown in FIG. 8, the link storage section 48 stores, as the information about notice links, a name of a notice link 481, a link source page 482, a link target page 483, an evaluation result 484 by the link evaluation section 50 (described later) and a date and time 485 when this evaluation result 484 is written.

Based on the information about the notice links stored in the link storage section 48, the page generation section 49 inserts notice links in the page as a link source. Herein, the page generation section 49 inserts the notice links in the page as a link source in accordance with the insertion positions of the notice links stored in the link format storage section 41. Incidentally, the notice links may be displayed in the form of an image such as a banner on the browser of the user terminal 2, which is a non-limiting example. For instance, a notice link may be displayed as text information representing a title of a page as a link target, or may be displayed with text information desired by a site administrator. In this case, the site administrator can input the desired text information through the input section 40.

As one example, the page generation section 49 reads out information about the notice link A and the notice link B from the link storage section 48 shown in FIG. 8. The page generation section 49 further reads out the insertion positions of the notice link A and the notice link B stored in the link format storage section 41. The page generation section 49 inserts the notice link A and the notice link B in “page S1” as a link source in accordance with the read-out insertion positions. The page generation section 49 also inserts notice links B to D in the page as a link source similarly to the above-stated notice link A and the notice link B.

The page generation section 49 sends the webpage with notice links inserted therein to the web server 3. The web server 3 writes HTML of the sent webpage in the page storage section 30.

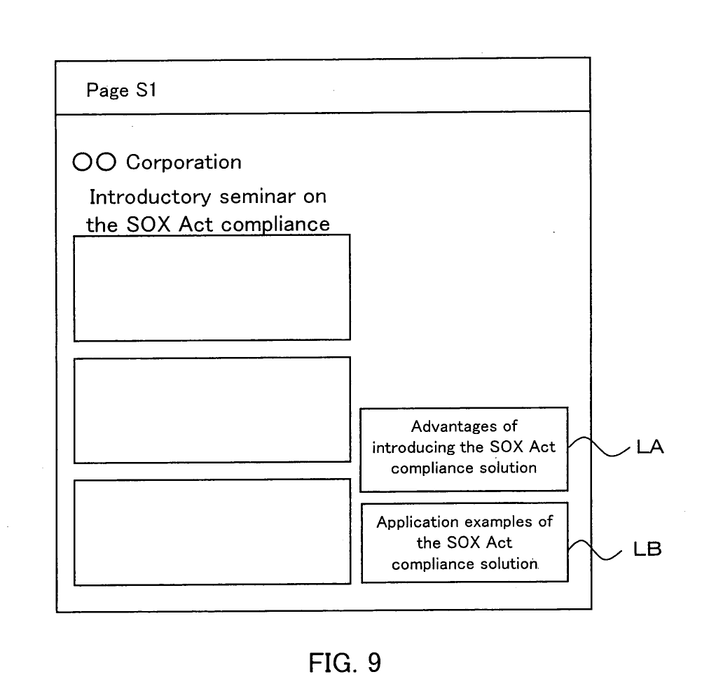

As one example, the webpage with notice links inserted therein may be displayed on the browser of the user terminal 2 as shown in FIG. 9. That is, “advantages of introducing the SOX Act compliance solution” LA corresponding to the notice link A and “application examples of the SOX Act compliance solution” LB corresponding to the notice link B are displayed in “page S1” as the link source. The “advantages of introducing the SOX Act compliance solution” LA and the “application examples of the SOX Act compliance solution” LB are displayed as text information representing titles of pages as link targets. In this example, when clicking the “advantages of introducing the SOX Act compliance solution” LA, the display is changed to the page concerning the “advantages of introducing the SOX Act compliance solution”. When clicking the “application examples of the SOX Act compliance solution” LB, the display is changed to the page concerning the “application examples of the SOX Act compliance solution”.

Based on the judgment results by the page judgment section 45 and the previous judgment results stored in the page judgment result storage section 46, the link evaluation section 50 evaluates as to whether or not the notice links stored in the link storage section 48 are effective notice links that are capable of making a user arrive at a goal page. The link evaluation section 50, for example, evaluates as to whether or not the notice links stored in the link storage section 48 are effective notice links every predetermined time period (e.g., on a weekly or monthly basis) or every time the webpage is updated.

Furthermore, the link evaluation section 50 may make the evaluations concerning the effective notice links or not using, as thresholds, the boundary conditions (Sa, Da) that are for the judgment between “customer-collecting page” and “conversion page” by the page judgment section 45. Thereby, since the page judgment by the page judgment section 45 and the evaluation of the notice links by the link evaluation section 50 can be made based on the same criteria, the configuration of the website construction support system 4 can be simplified.

That is, the link evaluation section 50 judges a notice link having an arrival frequency of the “customer-collecting page” as the link source larger than the threshold and having an access frequency to the “conversion page” as the link target larger than the threshold to be an effective notice link. On the other hand, the link evaluation section 50 judges a notice link having an arrival frequency of the “customer-collecting page” as the link source smaller than the threshold or a notice link having an access frequency to the “conversion page” as the link target smaller than the threshold to be an ineffective notice link.

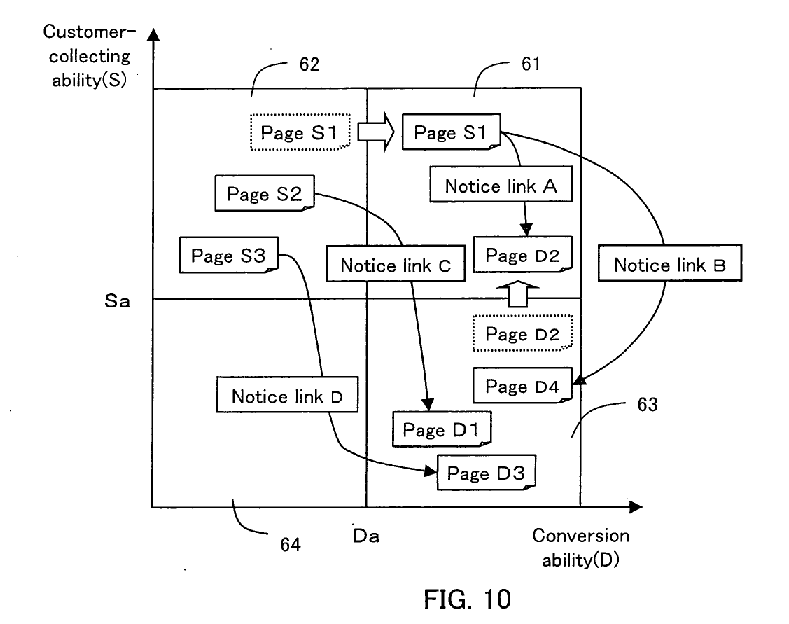

More specifically, as a result of the judgment by the page judgment section 45, it is assumed, for example, that page S1 as the link source is judged as “customer-collecting conversion page” as shown in FIG. 10. Similarly, it is assumed that page D2 as the link target is judged as “customer-collecting conversion page”, pages S2 and S3 as the link sources are judged as “customer-collecting pages” and pages D1, D3 and D4 as the link targets are judged as “conversion pages”. The page judgment result storage section 46 stores the previous judgment results showing that pages S1 to S3 are judged to be “238 representing a “customer-collecting page” and pages D1 to D4 are judged to be “338 representing a “conversion page”.

Herein, the link evaluation section 50 reads out the notice links A to D from the link storage section 48 shown in FIG. 8. Based on the judgment results by the page judgment section 45 and the previous judgment results stored in the page judgment result storage section 46, the link evaluation section 50 evaluates as to whether or not the read-out notice links A to D are effective notice links. In the example of FIG. 10, since page S1 as the link source is changed from “customer-collecting page” to “customer-collecting conversion page” and page D2 as the link target is changed from “conversion page” to “customer-collecting conversion page”, the link evaluation section 50 judges that the notice link A is an effective notice link. Since page S1 as the link source is changed from “customer-collecting page” to “customer-collecting conversion page” but page D4 as the link target still remains “conversion page” that is the same as in the previous judgment, the link evaluation section 50 judges that the notice link B is an ineffective notice link. Further, since page S2 as the link source is “customer-collecting page” that is the same as in the previous judgment and page D1 as the link target is “conversion page” that is the same as in the previous judgment, the link evaluation section 50 judges that the notice link C is an ineffective notice link. Further, page S3 as the link source is “customer-collecting page” that is the same as in the previous judgment and page D3 as the link target is “conversion page” that is the same as in the previous judgment, the link evaluation section 50 judges that the notice link D is an ineffective notice link.

After the link evaluation section 50 evaluates the notice links, the link evaluation section 50 writes the evaluation results (judgment results) of the notice links in the link storage section 48. For instance, as shown in FIG. 8, since the link evaluation section 50 judges the notice link A as an effective notice link, information “o” representing effective is written as an evaluation result 484 in the link storage section 48. On the other hand, since the link evaluation section 50 judges the notice links B to D as ineffective notice links, information “X” representing ineffective is written as effective results 484 in the link storage section 48. The link evaluation section 50 further writes “5/12/10:05:2138 that shows the date and time 485 when the evaluation results are written in the link storage section 48. This means that the evaluation results are written at 10:05:21 on May 12.

The link decision section 47 decides a “conversion page” that can replace the “conversion page” as the link target included in the ineffective notice link from the webpages judged by the page judgment section 45 as “conversion pages”. Then, the link decision section 47 generates a new notice link including the decided “conversion page” as a link target.

As one example, the link decision section 47 reads out the evaluation result 484 “o38 of the notice link A from the link storage section 48. The link decision section 47 further reads out the evaluation results 484 “X” of the notice links B to D from the link storage section 48. Then, the link decision section 47 generates new notice links instead of the notice links B to D whose read-out evaluation results 484 are “X”.

More specifically, the link decision section 47 decides a “conversion page” as a new link target at random from the webpages judged by the page judgment section 45 as “conversion pages”, which replaces page D4 as the link target of the notice link B, and generates a new notice link including the decided “conversion page” as the link target.

Herein, the link decision section 47 deletes the record of the notice link B stored in the link storage section 48, and writes information about the newly generated notice link in the link storage section 48. The link decision section 47 also deletes the record of the notice link C and the notice link D stored in the link storage section 48 similarly to the notice link B, and writes their respective information about the newly generated notice links in the link storage section 48.

The above description deals with the example where the link decision section 47 deletes the record of the ineffective notice links (in the above example, the notice links B to D) stored in the link storage section 48. However, the record may not be deleted. In this case, the evaluation results of the notice links by the link evaluation section 50 may be accumulated in the link storage section 48. Thereby, a highly detailed control can be performed, for example, even the “conversion page” as the link target in the ineffective notice link can return to a candidate of the “conversion page” as the link target after a predetermined time period has elapsed. Herein, whether the predetermined time period having elapsed or not can be judged by reading out the date and time 485 when the evaluation results are written in the link storage section 48.

The page generation section 49 inserts the notice link newly generated by the link decision section 47 in the page as the link source based on the information about the notice link written by the link decision section 47 in the link storage section 48, which replaces the ineffective notice link. Herein, the page generation section 49 inserts the newly generated notice link in the page as the link source in accordance with the insertion positions of the notice link stored in the link format storage section 41. The page generation section 49 sends HTML of the webpage with the notice link inserted therein to the web server 3. The web server 3 writes the sent HTML of the webpage in the page storage section 30. This means the update of the webpage in the page storage section 30.

Note here that the above-stated website construction support system 4 also can be implemented by installing a program in any computer such as a personal computer. That is, the above-stated input section 40, access long acquisition section 43, calculation section 44, page judgment section 45, link decision section 47, page generation section 49 and link evaluation section 50 can be embodied by the operation of a CPU of a computer in accordance with a program implementing the functions of these sections. Therefore, a program for implementing the functions of the input section 40, the access long acquisition section 43, the calculation section 44, the page judgment section 45, the link decision section 47, the page generation section 49 and the link evaluation section 50 as well as a recording medium with such a program recorded thereon also are one embodiment of the present invention. Meanwhile, the link format storage section 41, the goal page storage section 42, the page judgment result storage section 46 and the link storage section 48 can be implemented by storage devices that can be accessed from a built-in storage unit of a computer or the computer.

The following describes a website construction support process by the website construction support system 4 configured as stated above in detail, with reference to the drawings.

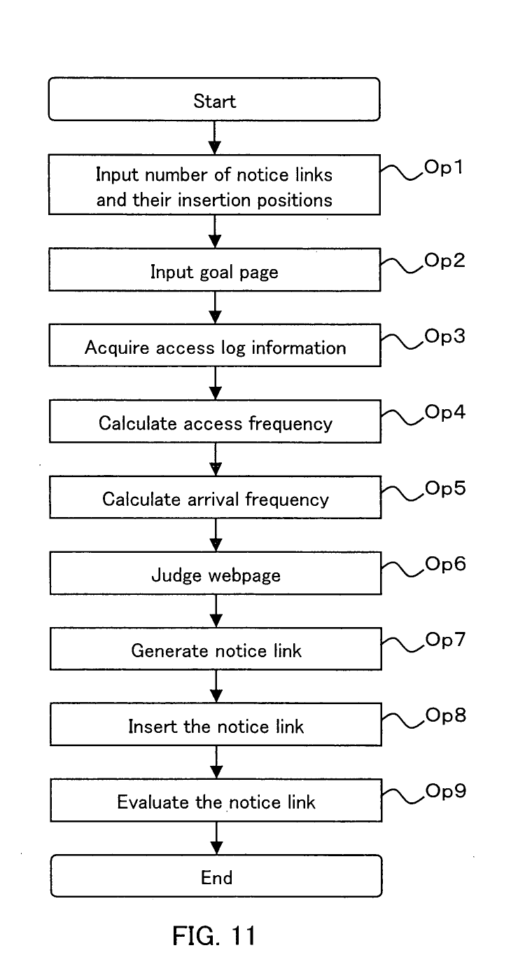

FIG. 11 is a flowchart briefly showing the website construction support process by the website construction support system 4. As shown in FIG. 11, according to the website construction support system 4, one webpage is specified using URL from webpages and the number of notice links to be inserted in this webpage and their insertion positions that are coordinates data of the notice links are input through input section 40 (Step Op1). The input number of the notice links and the insertion positions of the notice links are stored in the link format storage section 41. URL of a goal page also is input through the input section 40 (Step Op2). The input URL of the goal page is stored in the goal page storage section 42.

Next, the access log acquisition section 43 acquires access log information stored in the access log information storage section 31 of the web server 3 (Step Op3). The access frequency calculation section 44a calculates an access frequency to the webpage based on the access log information acquired by the access log acquisition section 43 (Step Op4). The arrival frequency calculation section 44b calculates an arrival frequency at the goal page based on the access log information acquired by the access log acquisition section 43 (Step Op5).

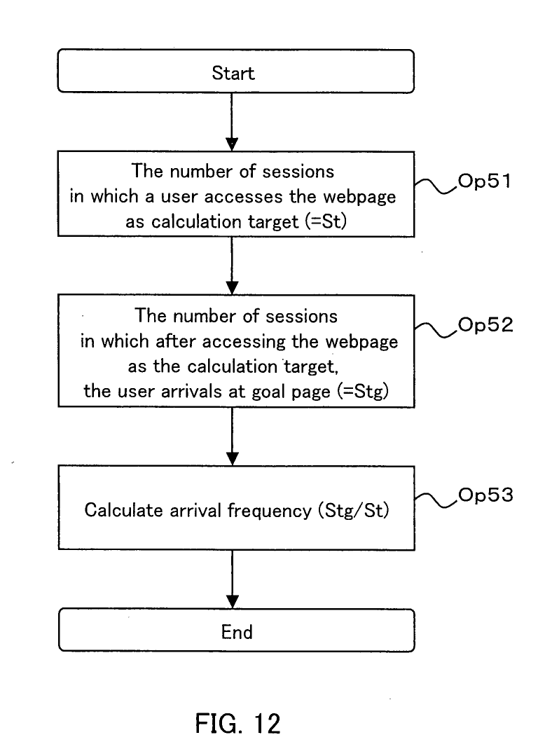

An exemplary process by the arrival frequency calculation section 44b at Step Op5 will be described below, with reference to FIG. 12.

FIG. 12 is a flowchart showing an exemplary process for calculating an arrival frequency by the arrival frequency calculation section 44b. As shown in FIG. 12, the arrival frequency calculation section 44b firstly calculates the number of sessions in which a user accesses the webpage as a calculation target of the arrival frequency (Step Op51). Herein, the calculated session number is assumed as St. Next, the number of sessions in which after accessing the webpage as the calculation target, the user arrivals at the goal page is calculated (Step Op52). That is, among the session number St calculated at Step Op51, the number of sessions in which the user arrivals at the goal page is calculated. Herein, the calculated session number is assumed as Stg. Then, based on the ratio between the session number St calculated at Step Op51 and the session number Stg calculated at Step Op52, the arrival frequency is calculated (Step Op53). In other words, the arrival frequency can be calculated by Stg/St.

The page judgment section 45 judges that a webpage having the access frequency calculated at Step Op4 larger than the boundary condition (Sa) is a “customer-collecting page” and a webpage having the arrival frequency calculated at Step Op5 larger than the boundary condition (Da) is a “conversion page” (Step Op6 of FIG. 11). The judgment results by the page judgment section 45 are stored in the page judgment result storage section 46. Based on the judgment results stored in the page judgment result storage section 46, the link decision section 47 generates a notice link in which a “customer-collecting page” is a link source and a “conversion page” is a link target (Step Op7). The information about the generated notice link is stored in the link storage section 48.

Based on the information about the notice link stored in the link storage section 48, the page generation section 49 inserts a notice link in the page as the link source (Step Op8). Herein, the page generation section 49 inserts the notice link in the page as the link source in accordance with the insertion positions of the notice link stored in the link format storage section 41. The page generation section 49 sends the webpage with the notice link inserted therein to the web server 3. The HTML of the sent webpage is stored in the page storage section 30 of the web server 3.

Then, after Step Op8, every predetermined time period (e.g., on a weekly or monthly basis) or every time the webpage is updated, for example, an evaluation is made as to whether or not the notice link stored in the link storage section 48 is an effective notice link capable of making a user arrive at the goal page (Step Op9).

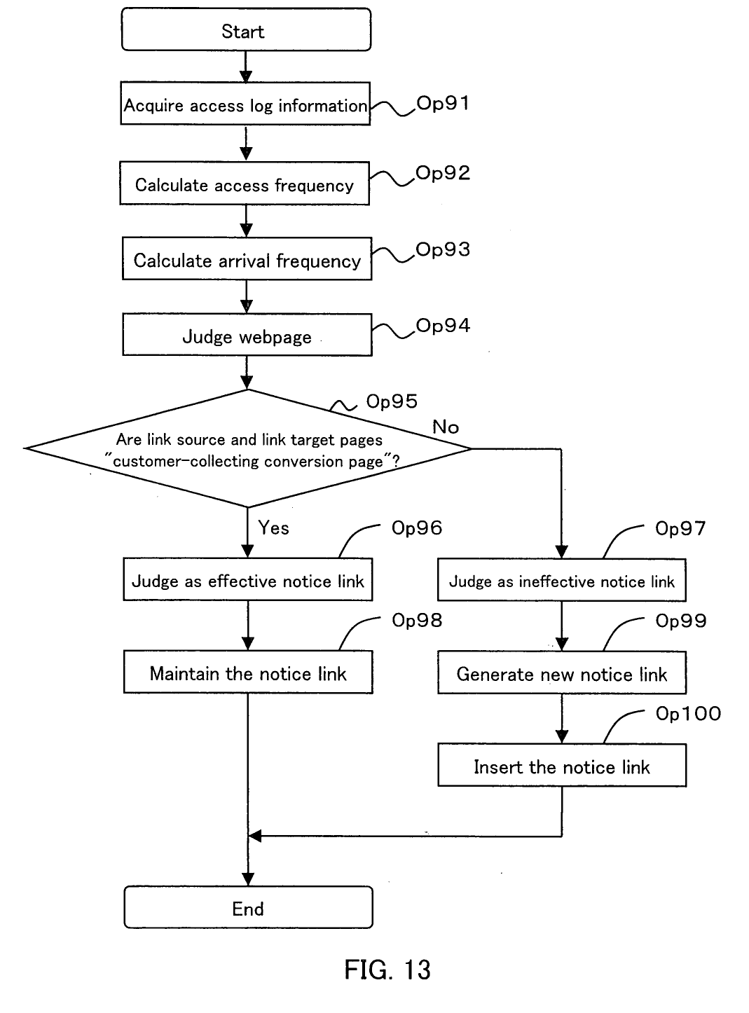

Referring now to FIG. 13, one exemplary process at Step Op9 for evaluating a notice link will be described below.

FIG. 13 is a flowchart showing one exemplary process for evaluating a notice link. As shown in FIG. 13, the access log acquisition section 43 acquires access long information from the access log information storage section 31 of the web server 3 (Step Op91). The access frequency calculation section 44a calculates an access frequency based on the acquired access log information (Step Op92) and the arrival frequency calculation section 44b calculates an arrival frequency based on the acquired access log information (Step Op93). The page judgment section 45 judges that a webpage having an access frequency larger than the boundary condition (Sa) is a “customer-collecting page” and a webpage having an arrival frequency larger than the boundary condition (Da) is a “conversion page” (Step Op94). Incidentally, Steps Op91 to Op94 are the same as Steps Op3 to Op6 of FIG. 11.

Next, based on the judgment results at Step Op94 and the previous judgment results stored in the page judgment result storage section 46, the link evaluation section 50 evaluates as to whether or not the notice link stored in the link storage section 48 is an effective notice link capable of making a user arrive at a goal page. More specifically, if the page as the link source and the page as the link target are changed to “customer-collecting conversion pages” (YES at Step Op95), the link evaluation section 50 judges it as an effective notice link (Step Op96). On the other hand, if the page as the link source and the page as the link target are not changed to “customer-collecting conversion pages” (No at Step Op95), the link evaluation section 50 judges it as an ineffective notice link (Step Op97). The evaluation result of the notice link judgment result) is stored in the link storage section 48.

The link decision section 47 maintains the notice link that is judged as effective at Step Op96 (Step Op98). Alternatively, the link decision section 47 decides, among the webpages judged as “conversion pages” by the page judgment section 45, a “conversion page” that replaces the “conversion page” as the link target in the notice link judged as ineffective at Step Op97, and newly generates a notice link including the decided “conversion page” as a link target (Step Op99). The information about the newly generated notice link is stored in the link storage section 48.

The page generation section 49 inserts the notice link newly generated by the link decision section 47 in the page as the link source based on the information about the notice link newly written by the link decision section 47 in the link storage section 48, which replaces the ineffective notice link (Step Op100). Herein, the page generation section 49 inserts the newly generated notice link in the page as the link source in accordance with the insertion positions of the notice link stored in the link format storage section 41. The page generation section 49 sends HTML of the webpage with the notice link inserted therein to the web server 3. The HTML of the sent webpage is stored in the page storage section 30 of the web server 3.

As stated above, according to the website construction support system 4 of the present embodiment, a notice link including a customer-collecting page as a link source and a conversion page as a link target is inserted in the customer-collecting page as the link source. This allows a large number of users who access the customer-collecting page to be guided to the conversion page, thus increasing the number of users who arrive at the goal page. Moreover, since there is no need for a site administrator to generate a notice link as in the conventional configuration, labor costs for the site administrator can be reduced.

Note here that the above-stated specific example simply shows a preferable embodiment of the website construction support system of the present invention, and various modifications are possible, for example, concerning the calculation process of an arrival frequency by the arrival frequency calculation section 44b and the method for deciding a link target by the link decision section 47.

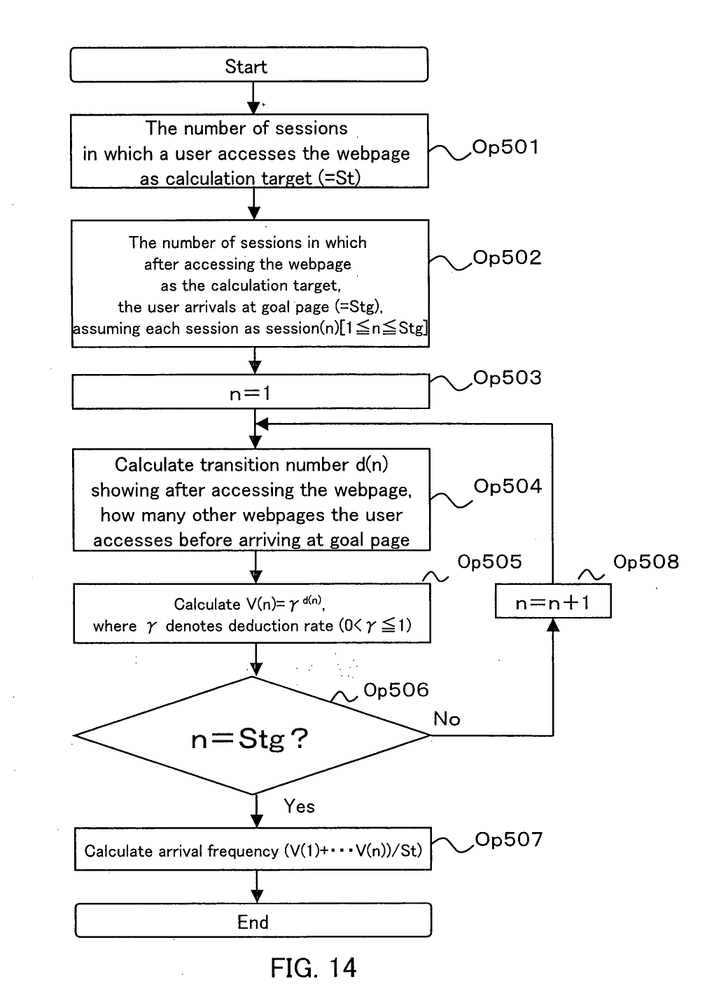

As one example, FIG. 14 shows another embodiment of the calculation process of an arrival frequency by the arrival frequency calculation section 44b (Step Op5 of FIG. 11). The procedure of FIG. 14 is an alternative way of that shown in FIG. 12. According to the procedure of FIG. 14, the arrival frequency calculation section 44b firstly calculates the number of sessions in which a user accesses the webpage as a calculation target of the arrival frequency (Step Op501). Herein, the calculated session number is assumed as St. Next, the number of sessions in which after accessing the webpage as the calculation target, the user arrivals at the goal page is calculated (Step Op502). That is, among the session number St calculated at Step Op501, the number of sessions in which the user arrivals at the goal page is calculated. Herein, the calculated session number is assumed as Stg, and each session is assumed as session(n) [1≦n≦Stg]. Incidentally, Steps Op501 and Op502 are the same as Steps Op51 and Op52 of FIG. 12.

Next, the arrival frequency calculation section 44b initializes the variable n as “138 (Step Op503). The arrival frequency calculation section 44b calculates a transition number d(n) that shows after accessing the webpage, how many other webpages the user accesses before arriving at the goal page during the session(n) [1≦n≦Stg] (Step Op504). Based on the transition number d(n) calculated at Step Op504, the arrival frequency calculation section 44b calculates V(n) (Step Op505). V(n) can be calculated with the relationship of V(n)=γ^{d(n)}, where γ denotes a deduction rate having a value in the range of 0<γ≦1. Thereby, V(n) decreases with an increase of the transition number d(n).

If the calculation of V(n) has been completed (n=Stg) about all sessions(n) [123 n≦Stg] (YES at Step Op506), the arrival frequency calculation section 44b calculates an arrival frequency (Step Op507). More specifically, the arrival frequency calculation section 44b calculates the arrival frequency based on the ratio between the session number St calculated at Step Op501 and V(1), V(2), . . . V(n) calculated at Step Op505. In other words, the arrival frequency can be calculated with the relationship of V(1)+V(2)+ . . . +V(n)/St.

On the other hand, if the calculation of V(n) has not been completed (n≠Stg) about all sessions (n) [1≦n≦Stg] (NO at Step Op506), the arrival frequency calculation section 44b adds “138 to the variable n (n=n+1) (Step Op508) and repeats Step Op504 and Step Op505.

As stated above, the arrival frequency calculation section 44b can calculate the arrival frequency by the procedure shown in FIG. 14 as well. That is, according to the procedure of FIG. 14, the arrival frequency can be deducted by the amount corresponding to an increase in the transition number d(n) showing the access by the user to other webpages after accessing the webpage as the calculation target and before arriving at the goal page. According to this procedure, an arrival frequency that reflects the arrival state of the user more accurately can be obtained as compared with the procedure of FIG. 12.

The above-description shows the example in which the link decision section 47 decides a “conversion page” as the link target at random from the webpages judged by “conversion pages” by the page judgment section 45. This is a non-limiting example. For instance, the link decision section 47 may calculate a similarity between the “customer-collecting page” as the link source and the webpages judged as “conversion pages” by the page judgment section 45 and generate a notice link including the webpage having the highest similarity as the link target. When the “conversion page” as the link target is decided based on a similarity, a notice link can be generated between webpages having a closer relationship than the case of deciding the “conversion page” as the link target at random.

Herein, the similarity may be calculated, for example, by extracting nouns in sentences of the respective webpages as the comparison target, while calculating a vector of the number of occurrence of the extracted nouns and the occurrence frequency, and calculating the similarity using the magnitude of the angle of the calculated vector. However, this is a non-limiting example. For instance, the similarity may be calculated using a conventionally known algorithm that is for calculating a similarity.

The above description shows the example in which the link decision section 47 generates a notice link including a “customer-collecting page” as a link source and a “conversion page” as a link target. However, preferably, the notice link is generated so as to exclude the top page of the website from the “customer-collecting page” as the link source. This is because since the top page is an entrance of the website, the top page will have the highest access frequency among all webpages constituting the website. Alternatively, the site administrator may designate, through the input section 40, a webpage to be excluded from the target for generating a notice link by the link decision section 47. Thereby, the webpage that is not suitable for the link source and the link target of the notice link can be excluded.

The above description shows the example in which the link evaluation section 50 makes an evaluation about an effective notice link or not using the boundary conditions (Sa, Da) as thresholds, which are used for the judgment between “customer-collecting page” and “conversion page” by the page judgment section 45. However, this is a non-limiting example. For instance, the link evaluation section 50 may use any values as thresholds instead of the boundary conditions (Sa, Da) used by the page judgment section 45. Thereby, the link evaluation section 50 can make a highly detailed evaluation concerning an effective notice link or not.

The above description shows the example in which the link evaluation section 50 judges as an effective notice link a notice link including the page as the link source with an arrival frequency larger than the threshold and the page as the link target with an access frequency larger than the threshold. However, this is a non-limiting example. For instance, the link evaluation section 50 may judge a notice link as an ineffective notice link, even when it includes the page as the link source with an arrival frequency larger than the threshold and the page as the link target with an access frequency larger than the threshold, as long as the page as the link target has an arrival frequency smaller than the threshold. That is, there is a high probability that the notice link including the page as the link target with the arrival frequency smaller than the threshold confuses the user. Therefore, it is preferable that the notice link including the page as the link target with the arrival frequency smaller than the threshold is judged as an ineffective notice link that is incapable of making the user arrive at the goal page.

### Embodiment 2

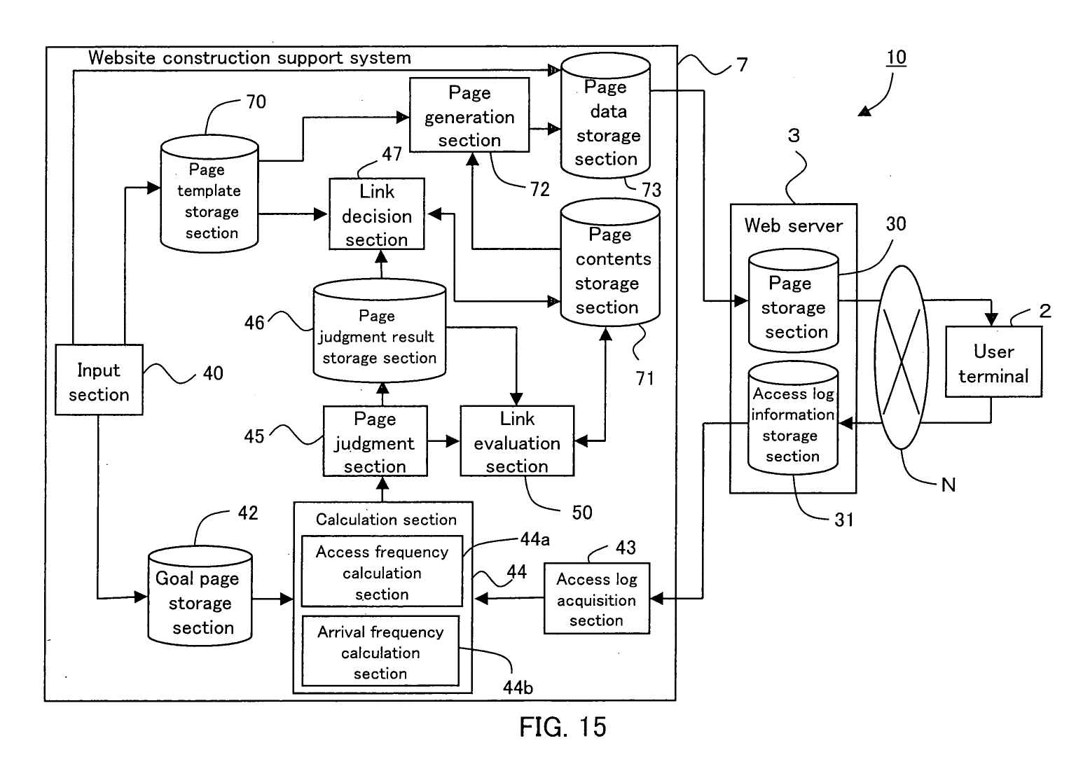

FIG. 15 is a block diagram schematically showing the configuration of a network system 10 according to the present embodiment. The same reference numerals are assigned to the elements having functions similar to those described for the configuration of FIG. 3, and their detailed explanations are not repeated.

A website construction support system 7 according to the present embodiment functions as a Contents Management System (CMS). To this end, the website construction support system 7 includes a page template storage section 70, a page contents storage section 71, a page generation section 72 and a page data storage section 73. In general, the contents management system refers to a system that collectively maintains and manages webpages constituting a website and is capable of constructing and editing the website.

The page template storage section 70 stores a page template made up of layout information (style sheet) of a webpage, common design elements and the like. This page template includes the number of notice links input through an input section 40 and insertion positions of coordinates data of the notice links. That is to say, the page template storage section 70 includes the link format storage section 41 of FIG. 3.

The page contents storage section 71 stores contents of pages made up of text, images and the like of webpages. These page contents include information about notice links generated by a link decision section 47. That is to say, the page contents storage section 71 includes the link storage section 48 of FIG. 3. The page contents are stored in the form of eXtensible Markup Language (XML).

The page generation section 72 has a function of generating HTML of a webpage based on the page template stored in the page template storage section 70 and the page contents stored in the page contents storage section 71, as well as the function of the page generation section 49 of FIG. 3.

Furthermore, when generating the HTML of a webpage, the page generation section 72 inserts notice links in a page as a link source based on the information about the notice links included in the page contents. Herein, the page generation section 72 inserts the notice links in the page as the link source in accordance with the insertion positions of the notice links included in the pate template. The page generation section 72 writes the generated webpage in the page data storage section 73 described later.

The page data storage section 73 is a staging database that is for temporarily storing the HTML of the webpage generated by the page generation section 72. Herein, when a site administrator (site supervisor) gives authorization through the input section 40, the page data storage section 73 sends the stored HTML of the webpage to the web server 3. The page data storage section 73 may send the stored HTML of the webpage to the web server 3 based on a predetermined timing for public view.

As stated above, according to the website construction support system 7 of the present embodiment also, a notice link including a customer-collecting page as a link source and a conversion page as a link target is inserted in the customer-collecting page as the link source. This allows a large number of users who access the customer-collecting page to be guided to the conversion page, thus increasing the number of users who arrive at the goal page. Moreover, since there is no need for a site administrator to generate a notice link as in the conventional configuration, labor costs for the site administrator can be reduced.

### Embodiment 3

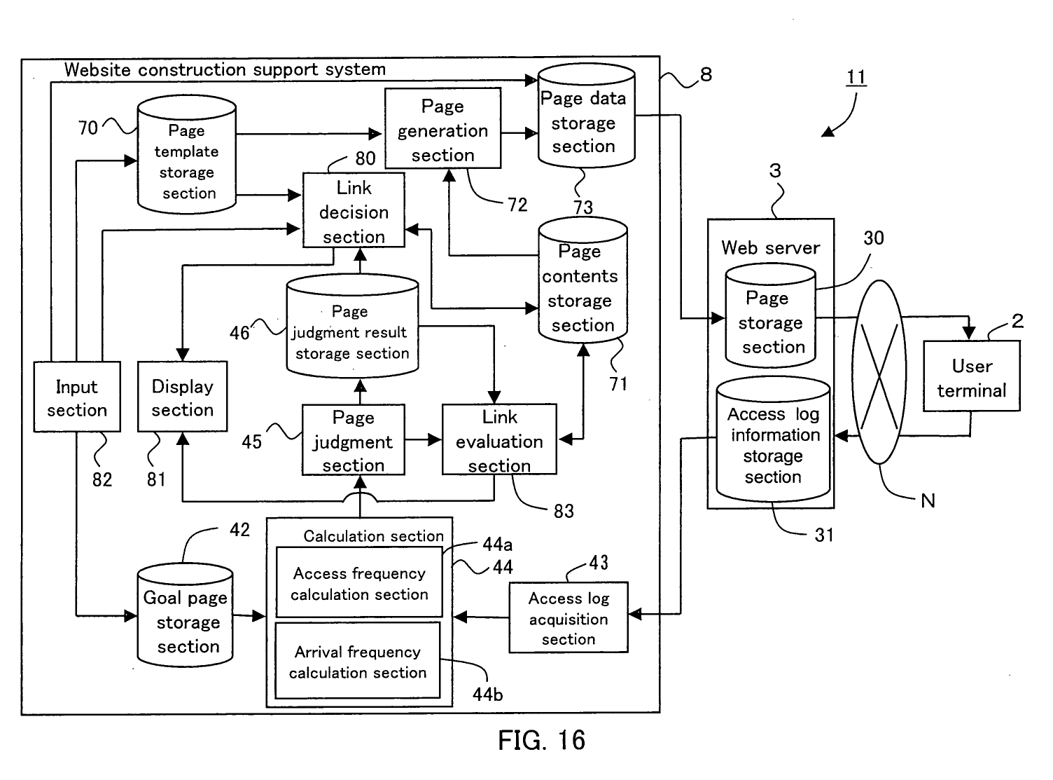

FIG. 16 is a block diagram schematically showing the configuration of a network system 11 according to the present embodiment. The same reference numerals are assigned to the elements having functions similar to those described for the configuration of FIG. 15, and their detailed explanations are not repeated.

A website construction support system 8 according to the present embodiment also functions as a contents management system. Unlike Embodiment 2, the present embodiment is configured so that candidates for a notice link are presented to a site administrator so as to allow the site administrator to select desired notice links, while evaluation results of the notice links are presented to the site administrator so as to allow the site administrator to instruct the update of the notice links. To this end, the website construction support system 8 includes a link decision section 80, a display section 81, an input section 82 and a link evaluation section 83.

The link decision section 80 has a function of reading out the number of notice links stored in a page template storage section 70 and generating notice links exceeding the number of the read out notice links, as well as the function of the link decision section 47 of FIG. 15. For instance, in the case where the number of read out notice links is “238 , the link decision section 80 generates four notice links that is twice the read out notice links. The link decision section 80 outputs the generated plurality of notice links to the display section 81 described below.

The display section 81 displays the plurality of notice links generated by the link decision section 80 as candidates for a notice link. The display section 81 displays the candidates of a notice link in list form, for example.

The input section 82 has a function of allowing the site administrator to input (select) his/her desired notice link from the candidates for a notice link displayed on the display section 81, as well as the function of the input section 40 of FIG. 14. The input notice link is output to the link decision section 80.

The link evaluation section 83 has a function of outputting the evaluation results of the notice links to the display section 81, as well as the function of the link evaluation section 50 of FIG. 14.

The display section 81 displays the evaluation results of the notice links by the link evaluation section 83. For instance, the display section 81 displays the evaluation results of the notice links by the link evaluation section 83 so that they are divided into effective notice links and ineffective notice links.

The input section 82 has a function of allowing the site administrator to input as to whether a new notice link is to be generated or not based on the evaluation results of the notice links displayed on the display section 81. The input instruction is output to the link decision section 80. Thereby, even an ineffective notice link can be maintained depending on the judgment by the site administrator. Furthermore, even an effective notice link can be updated to a new notice link depending on the judgment by the site administrator. Thus, a notice link corresponding to the actual conditions more can be inserted.

As stated above, according to the website construction support system 8 of the present embodiment also, a notice link including a customer-collecting page as a link source and a conversion page as a link target is inserted in the customer-collecting page as the link source. This allows a large number of users who access the customer-collecting page to be guided to the conversion page, thus increasing the number of users who arrive at the goal page. Moreover, since there is no need for a site administrator to generate a notice link as in the conventional configuration, labor costs for the site administrator can be reduced.

In this way, the present invention is effective as a website construction support system, a website construction support method and a recording medium with a website construction support program recorded thereon, by which link information for guiding a user to a goal page is effectively inserted in a webpage without the necessity of labor costs.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A website construction support system, comprising:
an input section that enables input of a goal page among a plurality of webpages constituting a website;
an access log acquisition section that acquires access log information representing history of accesses to the webpages;
an access frequency calculation section that calculates an access frequency to the webpages based on the access log information acquired by the access log acquisition section;
an arrival frequency calculation section that calculates an arrival frequency at the goal page based on the access log information acquired by the access log acquisition section;
a page judgment section that makes a judgment so that a webpage with the access frequency larger than a boundary condition is a customer-collecting page and a webpage with the arrival frequency larger than a boundary condition is a conversion page;
a page judgment result storage section that stores a result of the judgment by the page judgment section;
a link decision section that generates, based on the judgment result stored in the page judgment result storage section, link information including a customer-collecting page as a link source and a conversion page as a link target; and
a page generation section that inserts the link information generated by the link decision section in the customer-collecting page as the link source.

2. The website construction support system according to claim 1, further comprising a link evaluation section that judges, as ineffective link information, link information including a customer-collecting page as a link source with an arrival frequency smaller than a threshold or link information including a conversion page as a link target with an access frequency smaller than a threshold,
wherein the link decision section decides, from webpages judged as conversion pages by the page judgment section, a conversion page that replaces a conversion page as a link target in ineffective link information, and newly generates link information including the decided conversion page as a link target, and
the page generation section inserts the link information newly generated by the link decision section in the customer-collecting page as the link source, instead of the ineffective link information.

3. The website construction support system according to claim 2, wherein the link evaluation section judges, as effective link information, link information including a customer-collecting page as a link source with an arrival frequency larger than a threshold and a conversion page as a link target with an access frequency larger than a threshold.

4. The website construction support system according to claim 2, wherein the link evaluation section uses the boundary conditions for the judgment by the page judgment section of customer-collecting pages and conversion pages as the thresholds.

5. The website construction support system according to claim 1, wherein the link decision section decides, from webpages judged as conversion pages by the page judgment section, a conversion page as a link target at random, and generates link information including the decided conversion page as a link target.

6. The website construction support system according to claim 1, wherein the link decision section calculates a similarity between the customer-collecting page as the link source and webpages judged as conversion pages by the page judgment section and generates link information including a webpage having the highest similarity as a link target.

7. The website construction support system according to claim 1, wherein the arrival frequency calculation section calculates the arrival frequency based on a ratio between the access frequency to the webpages and the number of arrivals to the goal page after accessing the webpages.

8. A website construction support method, comprising the steps of:
an input step of enabling input of a goal page among a plurality of webpages constituting a website;
an access log acquisition step of acquiring access log information representing history of accesses to the webpages;
an access frequency calculation step of calculating an access frequency to the webpages based on the access log information acquired at the access log acquisition step;
an arrival frequency calculation step of calculating an arrival frequency at the goal page based on the access log information acquired at the access log acquisition step;
a page judgment step of making a judgment so that a webpage with the access frequency larger than a boundary condition is a customer-collecting page and a webpage with the arrival frequency larger than a boundary condition is a conversion page;
a page judgment result storage step of storing a result of the judgment at the page judgment step in a page judgment result storage section;
a link decision step of generating, based on the judgment result stored in the page judgment result storage section, link information including a customer-collecting page as a link source and a conversion page as a link target; and
a page generation step of inserting the link information generated at the link decision step in the customer-collecting page as the link source.

9. A recording medium on which a website construction support program is recorded thereon, the website construction support program making a computer execute the processes of:
an input process of enabling input of a goal page among a plurality of webpages constituting a website;
an access log acquisition process of acquiring access log information representing history of accesses to the webpages;
an access frequency calculation process of calculating an access frequency to the webpages based on the access log information acquired at the access log acquisition process;
an arrival frequency calculation process of calculating an arrival frequency at the goal page based on the access log information acquired at the access log acquisition process;
a page judgment process of making a judgment so that a webpage with the access frequency larger than a boundary condition is a customer-collecting page and a webpage with the arrival frequency larger than a boundary condition is a conversion page;
a page judgment result storage process of storing a result of the judgment at the page judgment process in a page judgment result storage section;
a link decision process of generating, based on the judgment result stored in the page judgment result storage section, link information including a customer-collecting page as a link source and a conversion page as a link target; and
a page generation process of inserting the link information generated at the link decision process in the customer-collecting page as the link source.
